(19) United States
(12) Patent Application Publication
(10) Pub. No.: US 2026/0168772 A1
(43) Pub. Date: Jun. 18, 2026

(54) DETECTION DEVICE FOR DETECTING AN EXPLOSIVE TARGET OBJECT IN THE GROUND

(71) Applicant: GLOBAL CLEARANCE SOLUTIONS AG, Freienbach (CH)

(72) Inventors: Dominic Graser, Tuttlingen (DE); Hagen Fischer, Märwil (CH)

(21) Appl. No.: 19/106,264

(22) PCT Filed: Aug. 31, 2023
(86) PCT No.: PCT/EP2023/073923

§ 371 Date: Feb. 25, 2025

(30) Foreign Application Priority Data
Sep. 1, 2022 (CH) CH001023/2022

(51) Int. Cl. F41H 11/136; G01S 7/03; G01S 13/86; G01S 13/88

(52) U.S. Cl. CPC F41H 11/136; G01S 7/032; G01S 13/86; G01S 13/885; G01S 13/887

(57) ABSTRACT

A detection device for detecting an explosive target object which is arranged up to 6 m deep below a ground surface, including a first measuring device for a magnetic field measuring method with at least one gradiometer, a second measuring device for an electromagnetic measuring method from the field of time-domain methods, a third measuring device for a ground radar method, and an evaluation device. A measurement surface of each measuring device is arranged at least adjacently to at least one measurement surface of one of the two other measuring devices. The evaluation device is capable of receiving and evaluating signals of the first, second and third measuring device in real-time and providing position information of the target object below a detection surface which was situated in the measurement surfaces of all three measuring devices, from a combination of the evaluated signals of the first, second and third measuring device.

### BACKGROUND OF THE INVENTION

### Field of the Invention

The invention relates to the field of the detection of explosive objects in the ground.

### Description of Related Art

Devices and method for detecting explosive objects are already known in different variations and are used worldwide, for example in the field of ordnance clearance. A multitude of known devices and methods are already applied for clearing the ground of explosive objects. Herein, a contact-free detection is preferred for reasons of safety. With regard to explosive objects, it can herein be mines, explosive traps, explosives, explosive charges, scatter munitions, munitions and duds. However, unconventional ordnance (improvised explosive devices, IED for short) as are used for instance by terrorist groups can also be included amongst such explosive objects. Different known devices utilise different measuring methods for the detection, wherein the measuring methods each have individual advantages and disadvantages.

Known detection devices include for example electromagnetic active locators, thus an electromagnetic measuring method. Herein, a magnetic field is generated in a coil through which current flows, by way of electromagnetic induction, and in turn an eddy current arises in a metallic target object by way of this magnetic field. This eddy current generates its own magnetic field which is counter to the exciting magnetic field and weakens this. This weakening can be utilised in order to detect the presence of metallic objects. Herein, ferroelectric as well as non-ferroelectric metals can be detected. The disadvantage of an electromagnetic measuring method is the exclusive detection of metal parts, and even this is still dependent on the conductivity and permeability of the metal type. As soon as a target object includes less metal and/or a metal type with a reduced eddy current capacity, it is then only a correspondingly low weakening of the magnetic field which occurs. The electromagnetic measuring method can furthermore only detect objects in the ground at a limited depth. For this reason, it is often only used for searching for objects which are close to the surface of the ground. Moreover, each influence of the electromagnetic radiation in the measurement region effects an interference of the measuring signals of the electromagnetic measuring method. A combination with other measuring methods which influence the electromagnetic radiation is therefore cumbersome and complicated.

Other known detection devices include for example a magnetic field measuring method. Herein, a measurement of a magnetic field is effected with a magnetometer. The magnetic field measuring method permits a direct detection of ferromagnetic metal parts (thus not of non-ferrous metals which is to say non-ferromagnetic metals such as aluminium), and this being the case depending on the conductivity and permeability of the metal type, which accordingly restricts the application of the magnetic field measuring method. A magnetic field measuring method is for example quite suitable in order to detect ferromagnetic metal objects at great depths of up to 6 metres. Moreover, on application, the magnetic field measuring method can measure a natural magnetic signature of the ground and accordingly also a change of this, such a change being created for example by way of excavation or an object impact. A correct interpretation of the measuring signals of the magnetic field measuring method is not always easy. And common magnetic field measuring arrangements such as proton magnetometers, caesium magnetometers or simple Hall-sensors have the disadvantage that to some extent they entail cumbersome and/or complex constraints, such as the fact that they necessitate a high cooling of the sensors and/or have a large construction size. This is disadvantageous given an application on a terrain and with regard to the transportability. Furthermore, a magnetic field measuring method by way its very nature reacts sensitively to changes of the magnetic field, thus also to changes which are not caused by the target object, for example due to (in particular ferromagnetic) objects in the environment of the detection device. A combination with measuring methods which influence the magnetic field in the measurement region (such as due to the radiation of electromagnetic radiation as with the electromagnetic measuring method) is therefore cumbersome and complicated.

In turn, other detection devices include a ground radar. Electromagnetic waves are emitted in a ground radar and these are reflected by the target object and then received by the ground radar again and evaluated. In this manner, all differences of the nature of the ground can be detected, for example, anomalies such as the sought explosive objects, but also stones or other natural and unnatural inhomogeneities of the ground which are not sought for. On the upside, non-metallic objects or objects with a reduced metal content (such as e.g. IDEs) can be well detected. However, the deeper in the ground one is to measure with the ground radar, the lower must the measurement frequency be and due to this the measurement has a poorer spatial resolution and thus becomes less accurate. The ground radar reacts sensitively to changes of electromagnetic waves and their reflection behaviour in the measurement region, by which means the measurement can become adulterated. Due to this, a ground radar is sensitive with regard to all sources of electromagnetic radiation, in particular to radiation sources as are used for instance with the electromagnetic measuring method. A combination with other measuring methods which influence electromagnetic radiation is therefore cumbersome and complicated.

Other measuring methods are used in known devices for the purpose of the detection of explosive objects. A different measuring method is therefore used depending on the application purpose, with the corresponding advantages and disadvantages. Sometimes several different devices which use different measuring methods are also applied successively for detection. This however requires much effort and is inefficient as well as dangerous, if for example an explosive object although being detectable with one of the used devices, it is however another device which poorly detects this explosive object or does not detect it at all which is used first of all, and an application of this device could for example mechanically lead to an explosion of the object.

Devices which combine one of the measuring methods with a second one in a single device also already exist. For example, a detection device which simultaneously includes a ground radar and a metal detector using an electromagnetic measuring method is described in EP2616837. Herein, a specific spatial arrangement of the metal detector and the ground radar is necessary (metal detector perpendicular to the ground radar structure), in order to permit this combination of measuring methods for the same measurement region without excessively interfering with the respective measuring signals. A combination of several measuring methods is difficult to accomplish without these mutually influencing and interfering with one another.

### SUMMARY OF THE INVENTION

It is therefore the object of the invention to provide a detection device of the initially mentioned type which at least partly remedies at least one of the aforementioned disadvantages.

This object is achieved by a detection device with the features of the respective independent patent claim. Advantageous embodiments can be derived from the dependent claims, the description and/or the figures.

The detection device according to the invention serves for a detection of an explosive target object which is arranged up to maximally 6 m below the surface the ground. The detection device includes a first measuring device for a magnetic field measuring method with at least one gradiometer, a second measuring device for an electromagnetic measuring method from the field of time-domain methods, a third measuring device for a ground radar method and an evaluation device. Herein, a measurement surface of each measuring device is arranged at least adjacently to at least one measurement surface of one of the two other measuring devices. The evaluation device is capable of receiving signals of the first, second and third measuring device and of evaluating them in real-time. The evaluation device is also capable of providing position information of the target object below the detection surface which was situated in the measurement surfaces of all three measuring devices, from a combination of the evaluated signals of the first, second and third measuring device.

The detection device according to the invention combines measuring devices of a magnetic field measuring method, of an electromagnetic measuring method and of a ground radar method. Since generally the measuring methods of magnetic field measurement, electromagnetic measurement and ground radar in principle can fundamentally mutually influence one another and interfere with one another, concerning the detection device according to the invention a deliberate selection of specific sub-types of the measuring methods has been made in order to permit a combination of these measuring methods: the magnetic field measuring method encompasses at least one gradiometer, and the applied electromagnetic measuring method comes from the field of time-domain methods.

A gradiometer utilises two separate magnetic field sensors. Herein, one sensor measures the surroundings, and a measurement which is adjusted by the surroundings can be effected by way of determining a difference to the second sensor. In this manner, given a spatial arrangement and a temporal control of the gradiometer, such being selected in a targeted manner, on account of the gradiometer the magnetic field measuring method can be combined with other measuring methods which for example emit electromagnetic radiation. Expressed differently: by way of a specific alignment of the two separate magnetic field sensors of the gradiometer to one another, changes of the magnetic field which are not caused by the target object-for example by electromagnetic radiation or by positional changes of the complete detection device-influence both magnetic field sensors to the same extent. On determining a difference between both magnetic field sensors, their influence is therefore cancelled and the magnetic field measuring method receives the signals from the target object independently of other changes of the magnetic field. For this reason, the magnetic field measuring method with at least one gradiometer and given a specific alignment of the gradiometer in the detection device according to the invention can be combined with a specifically selected electromagnetic measuring method and the ground radar method.

Moreover, compact and simple magnetic field sensors can be used in the gradiometer on account of the difference measurement and, despite this, such sensors lead to measurement signals which are of sufficient quality for the present purpose. For example, fluxgate sensors are used for this.

Ferromagnetic objects can be detected at a ground depth of up to 6 m with the gradiometer, depending on the metal type, metal content and object size. The gradiometer is therefore quite suitable for a detection of explosive objects at relatively large ground depths. Given a suitable evaluation, even changes of a natural magnetic signature of the ground can be measured by the gradiometer, thus for example traces of excavations or of an object impact, which can indicate hidden explosive objects.

What is meant by the term below the surface of the ground or by the term depth or deep are distances in the direction of gravity. A part of the earth's surface, in particular of the ground of the earth is denoted as ground.

The electromagnetic measuring method from the field of time-domain methods utilises a high-frequency sequence of strong impulses which in the target object effect a rapid build-up of a strong magnetic field due to the induced eddy currents. On the one hand, a temporal separation of an emitting phase and of a receiving phase which is different thereto can be achieved by this sequence of impulses. This permits the application of high emitting powers which permits a high penetration depth into the ground. Moreover, the electromagnetic measuring method from the field of time-domain methods is particularly well suitable for a specifically adapted shape of a receiving coil which is designed separately from an emitting coil. Due to the targeted selection of the shape and arrangement of the receiving coil as well as of the emitting coil, the electromagnetic measuring method from the field of time-domain methods can hence be applied particularly well with other measuring methods which use electromagnetic signals. For the aforementioned reasons, the electromagnetic measuring method from the field of time-domain methods can be combined with a specific magnetic field measuring method and the ground radar method in the detection device according to the invention.

The electromagnetic measuring method from the field of time-domain methods can detect all metal types, but has a relatively low penetration depth into the ground. Typically, objects up to a depth of maximally 1 m in the ground are detected with this method. This method is hence suitable for the detection of explosive objects with a share of any metal, which are arranged close to the surface of the ground.

The ground radar can detect all ground anomalies and is suitable for the detection of explosive objects with a low metal share or even no share of metal. However, a correct evaluation of signals of the measuring device of the ground radar is important in order to differentiate natural ground anomalies such as stones, different ground layers, ground deformation, water accumulations, plant parts such as roots etc, from the sought explosive objects.

A large number of different explosive objects can be detected by way of a combination of the measuring signals of these three measuring methods. Herein, information which goes beyond a sum of individual measuring results from the combination of these measuring signals; depending on how strong and what is present as an evaluated signal in each case from an individual measuring method, a potential explosive object can be detected to an improved extent by combination than if the measuring methods are applied and evaluated individually in an isolated manner. A positive detection signal of one measuring method given the simultaneous absence of a detection signal of another measuring method, in a combination of all three measuring methods leads to good detection results for different types of explosive objects at different depths below the ground.

By way of this, the device according to the invention can detect explosive objects of three main categories of explosive objects: ferromagnetic objects (e.g. steel objects, shells, bombs, improvised explosive traps with a fragmentation casing), non-ferromagnetic or weakly ferromagnetic objects (e.g. objects including aluminium, explosive capsules, fuses of shells or mines) and metal-free objects (e.g. canisters filled with explosive mixture, so-called HME=homemade explosive).

For example, the combination of the evaluated signals of all three measuring methods for the detection surface, expressed in a greatly simplified manner and without dealing with a specific and adapted evaluation method, can result in the following: the gradiometer detects nothing, the electromagnetic measuring method of the field of time-domain methods detects a weak signal and the ground radar detects an object. From this one can deduce to a high probability a canister which is with an explosive capsule and which is arranged only slightly below the detection surface. Or the gradiometer detects an object, the electromagnetic measuring method from the field of time-domain methods detects nothing and the ground radar likewise detects nothing. From this, one can deduce that a metallic object is present at a great depth, for example an undetonated artillery shell 6 m deep below the detection surface. Or the gradiometer detects a slight change of the natural ground structure, the electromagnetic measuring method from the field of time-domain methods detects nothing and the ground radar detects a larger object close below the detection surface. From this, one can deduce that a metal-free explosive object could be present, for example a buried canister filled with explosive material, wherein a detonating cord branches away from the canister.

Furthermore, the detection device according to the invention includes a defined arrangement of measurement regions of the three measuring devices. The measurement region of a measuring device is a three-dimensional space which is surveyed by the measuring device. Expressed differently, a detection can be effected by the measuring device within the measurement region, but not outside the measurement region. A part of the ground surface which is covered by the measurement region is denoted as the measurement surface. The measurement surface is therefore an intersection of the measurement region and the surface of the ground.

The measurement surface of each measuring device is arranged at least adjacently to at least one measurement surface of one of the two other measuring devices. The measurement surfaces of two measuring devices of the detection device are then arranged at least adjacently if, at a location where the measurement surfaces are closest, they have a measurement surface distance of maximal 0.5 m, wherein measurement surfaces which are also directly adjacent to one another or partly overlap are denoted as being arranged at least adjacently. Expressed differently, a measurement surface is denoted as being at least adjacent to another measurement surface when both measurement surfaces partly overlap or both measurement surfaces are directly adjacent to one another or a smallest distance between the two measurement surfaces has a measurement surface distance of maximally 0.5 m. The measurement surface distance can also be maximally 0.3 m. In particular, the measurement surface distance is maximally 0.1 m.

Expressed differently, the measurement regions of the three measuring devices are arranged at least adjacently in the region of the surface of the ground.

Due to this at least adjacent arrangement of the measurement surfaces of the different measuring devices, it is possible to combine the different measuring methods into a common detection device without the mutual influencing leading to significant problems. For example, a resolution of the electromagnetic field measuring method worsens if its measurement surface is the same as that of the ground radar method.

The detection surface is a part of the ground surface which was situated in the measurement surfaces of all three measuring devices of the detection device. Expressed differently, measuring signals of all three measuring devices are available for the detection surface. The detection surface was surveyed by all three measuring devices and is part of the ground surface.

On account of the measurement surfaces of the measuring devices which are arranged at least adjacently, as a rule measurements with the measurement surfaces at different positions are necessary, in order to achieve a relevantly large detection surface. Since the detection device is typically used for the detection of explosive objects in larger ground surfaces such as paths, fields, border zones or parts of war regions, a position change of the detection device or its measurement surfaces is common. A detection surface results from a combination of all measurements by way of several measurements with the measurement surfaces at different spatial positions, the detection surface having been covered by all three measuring devices.

The evaluation device of the detection device receives signals of all three measuring devices and evaluates these in real time. Herein, the evaluation device assigns a spatial position of the respective measurement surface of the respective measuring device to the signals of each measuring device. This permits the evaluation device to determine a detection surface in which signals of all three measuring devices are present. And for the detection surface, the evaluation device can therefore provide position information of a detected target object by way of the evaluation device combining with one another the evaluated signals of all three measuring devices of the detection device within the detection surface.

The position information of the target object is information as to whether the detection device has detected an explosive target object or not, as well as a spatial position detail regarding the target object, inasmuch as such has been detected. The position information thus includes information as to below which location of the detection surface the target object lies or whether no target object has been detected. In particular, the position information can include information as to the depth below the detected location at which the target object is arranged.

The position information that no target object has been detected below the detection surface indicates that an explosive target object is not to be reckoned with below the detection surface. In this case a suitable all-clear can be given for this detection surface. And a position information with a position detail of a target object indicates the position on the detection surface (and optionally at which depth therebelow) at which an explosive target object is to be reckoned with. Suitable steps can then be initiated (e.g. defusing, retrieving, bringing the target object to explode and/or a cordoning off the dangerous ground surface). A non-detection of a target object as well as a detection of a target object as well as its spatial position are important pieces of position information.

Optionally, the detection device includes a display device which is capable of graphically representing the position information of the target object which is provided by the evaluation device.

The position information can be represented in a rapid and simply understandable manner by way of the display device. This simplifies a use of the detection device and renders the application intuitive. A correct operation of the detection device is simplified and an incorrect operation is unlikely. For example, the detection device can also display the detection surface.

Alternatively or additionally, the position information of the target object which is provided by the evaluation device can also be represented by a display device or the like, the display device not being encompassed by the detection device. This analogously applies to the detection surface.

In particular, the detection device serves for the detection of an explosive target object which is arranged up to maximally 3 m deep below the surface of the ground. For example, the detection device serves for the detection of an explosive target object which is arranged up to maximally 1 m deep below the surface of the ground.

In particular, the first, second and the third measuring device are arranged on a common transportable platform.

The common transportable platform for the three measuring devices has the advantage that the respective measurement surfaces can be moved from one position to another position in a simple and efficient manner. The common transportable platform permits a stable fastening of the three measuring devices relative to one another, which can have a positive effect on the mutual influencing of the different measuring methods.

For example, the detection device can be used for a clearance of munitions. The munitions clearance can herein be of a military or civilian nature.

Further embodiments can be derived from the dependent patent claims.

Optionally, the detection device includes a control device which sets a temporal sequence of measurements of the first and second measuring device.

In particular, the control device sets a main cycle for measuring cycles of 1 Hz to 10 kHz. For example, the control device sets a main cycle for measuring cycles of 10 Hz to 5 kHz. The control device can also set a main cycle for measuring cycles of 100 Hz to 1 kHz.

The control device permits measuring procedures of the first and second measuring device to be placed into different time windows in a targeted manner within a measuring cycle, in order to permit a low negative mutual influencing. Expressed differently, by way of the control device measuring procedures of the first and the second measuring device can be temporally staggered in a targeted manner and in a manner such that a mutual interference of the measurements of the measuring devices is kept low.

For example, a measuring cycle includes the following sequence of measuring procedures: emitting phase of the second measuring device (of the electromagnetic measuring method), receiving phase of the second measuring device, attenuation phase of the emitting and receiving coils of the second measuring device, receiving phase of the first measuring device (of the magnetic field measuring method).

Alternatively, the detection device can be designed freely of a control device.

Optionally, the third measuring device for the ground radar method is arranged in the detection device spatially between the first measuring device for the magnetic field measuring method and the second measuring device for the electromagnetic measuring method. In particular, the first measuring device is arranged at a distance of at least 0.5 m from the second measuring device.

A spatial arrangement of the third measuring device between the first and the second measuring device permits a mutual influencing of the first and second measuring device to be kept low by way of the spatial remoteness from one another. Herein, this spatial arrangement of the three measuring devices permits a compact design of the detection device or its part including the measuring devices.

For example, the first measuring device can be arranged at a distance of at least 0.7 m from the second measuring device. The first measuring device can also be arranged at a distance of at least 0.9 m from the second measuring device.

Optionally, the third measuring device for the ground radar method is at least partly encompassed by a metal-containing shielding housing which spatially separates the third measuring device from the first measuring device and from the second measuring device and at least partly electromagnetically shields it.

The third measuring device is at least partly electromagnetically shielded from the first and second measuring device by the metal-containing shielding housing. This permits a reduced influence on the third measuring device by the first and the second measuring device. In this manner the third measuring device can be operated for example independently of a temporal cycling of the first and second measuring device.

In particular, the shielding housing for the third measuring device has a low metal share. What is meant by this is that the shielding housing has a metal thickness of maximal 1.5 millimetres and minimally 0.5 micrometers at the locations which are of relevance for the electromagnetic shielding. The metal thickness can also be maximally 1 millimetre and minimally 1 micrometer. In particular, the metal thickness is maximally 0.5 millimetres and minimally 2 micrometers.

On account of the low metal share, the first and the second measuring device are influenced only to a small extent, but despite this the third measuring device is electromagnetically shielded from these.

Optionally, the low metal share of the shielding housing includes non-ferromagnetic metal, in particular aluminium. In this manner, the magnetic field measuring method is not influenced by the shielding housing. The metal share of the shielding housing can also include copper. Alternatively, it can include stainless steel of a low metal share.

In particular, the low metal share can be deposited onto shielding housing by way of vapour deposition.

Optionally, the third measuring device is designed for an application of an impulse radar method as a ground radar method.

Impulse radar methods denote methods which emit impulses and can measure a distance due to the measured duration until the reception of the corresponding reflected waves. This is particularly well suited to the detection device, in order to be able to determine an exact as possible location position of the target object. In contrast to a permanent radar method, the device with the impulse radar method also does not need to be moved in order to be able to determine a relevant measuring result.

Optionally, the impulse radar method is an ultra-wide-band pulse radar method.

The ultra-wide-band pulse radar method (so-called UWB) can be evaluated in real-time with common technical devices. At present, this is still difficult for other impulse radar methods due to the occurring large data quantity.

Optionally, the third measuring device includes a radar signal emitter which as an emitter signal is capable of emitting a rectangular impulse with an impulse duration of maximally 5 ns.

The impulse duration can for example also be maximally 2.5 ns. In particular, the impulse duration is maximally 1 ns.

The rectangular impulse with the impulse duration of maximally a few ns has the advantage that the received reflected waves can be easily recognised on account of the changed rectangular shape and the change of the rectangular shape can be evaluated for a higher resolution.

Alternatively, the emitting signal can also have a shape other than a rectangular impulse. The rectangular impulse can also last longer than maximally 5 ns.

Optionally, the third measuring device includes a radar signal control device which sets a cycle for measuring cycles of at least 1 Hz and at the most 100 Hz for the third measuring device.

In particular, the radar signal control device sets a cycle of at least 1 Hz and at the most 50 Hz. The radar signal control device can set a cycle of at least 5 Hz and at the most 25 Hz.

What is meant by a measuring cycle for the third measuring device is that the ground radar method completes a complete measurement including the emitting and receiving of electromagnetic waves and begins again with a new measurement.

Optionally, the third measuring device as a radar signal receiver includes at least two Vivaldi antennae which are arranged parallel to one another.

Vivaldi antenna permit a reception of a wide-band signal with a high power. A ratio between the antenna gain, shielding ability and adaption of the input reflection factor, in comparison to other antenna types is advantageous for this specific use in the detection device. By way of this, Vivaldi antennae are well suited for a detection device having a radar method which detects objects in the ground.

In particular all Vivaldi antennae are designed of non-ferromagnetic metal, for example of aluminium. In this manner, the magnetic field measuring method which is insensitive to non-ferromagnetic metals is not influenced.

In particular, several Vivaldi antennae which are arranged in parallel next to one another are used as receiving coils. This increases a resolution of the ground radar. For example, at least three Vivaldi antennae are used. Also at least four Vivaldi Antennae can be used.

Optionally, the second measuring device is designed for an application of a pulse induction method as an electromagnetic measuring method, wherein concerning the pulse induction method, an evaluation of an attenuation time of a feedback impulse is effected.

The pulse induction method with the evaluation of the attenuation time of the feedback impulse differs from other pulse induction methods in that the attenuation time of the feedback impulse is evaluated instead of an evaluation of a voltage of the feedback impulse. This has the advantage that the measurement is less prone to disturbance. This means that disturbance factors have a lesser influence on the measurement. Compared to the evaluation of the voltage, a lower signal noise at a greater sensitivity is achieved by way of the evaluation of the attenuation time.

Optionally, the second measuring device includes at least one emitting coil and at least one receiving coil.

In particular, at least two receiving coils can be used. Also at least three receiving coils can be used. A use of several receiving coils increases the resolution of the electromagnetic measuring method.

In particular, the second measuring device includes precisely one emitting coil.

In particular, in the second measuring device each emitting coil is designed separately from each receiving coil.

Optionally, the detection device includes a holding device for a non-positive and contact-fit connection of the detection device to a transport means. Herein, in particular the holding device is arranged on the detection device in a manner such that the holding device lies closer to the second measuring device than to the third measuring device and the holding device lies closer to the second measuring device than to the first measuring device.

Expressed differently, the holding device is arranged at the second measuring device, and the first measuring device is arranged remotely from the holding device. This has the advantage that a metal share of the transport means which is arranged at the holding device is arranged as remotely as possible from the first measuring device and its influence on the magnetic field measurements can be kept low by way of this. The detection device can be fastened to a transport means and be moved from one position into another position in a simple, efficient and controlled manner by way of the holding device.

The transport means can be a land vehicle. The transport means can be a water vehicle, for example a movement means which is capable of floating, such as a boat. The transport means can be a hovercraft. The transport means is for example an aircraft or flying device. The transport means can be manned or unmanned. The transport means can be remote-controlled. The transport means can also be controlled autonomously.

Alternatively, the detection device is designed without a holding device. In particular, the detection device has its own means for transport.

Optionally, the detection device is designed as a module which can be connected to one or further detection device modules.

By way of the design of the detection device as a module, the measurement surfaces of all three measuring devices of the respective modules can be connected into a measurement surface which extends over several modules. On account of the design as a module the measurement surface of the detection device can be varied in a rapid and uncomplicated manner and be adapted to the local conditions and to the respective application. For example, the measurement surface can be kept narrow for narrow paths as in forests. The measurement surface can be enlarged for large open areas. A number of modules can be adapted to a carrying capability of transport means.

In particular, a detection device which is designed as a module has a measurement surface of a width of at least 0.4 m and of maximally 2 m. For example, the measurement surface is at least 0.7 m and maximally 1.7 m wide. The width of the measurement surface of a detection device which is designed as a module can be at least 1 m and maximally 1.4 m.

The width of the measurement surface of a measuring device is measured perpendicularly to a direction in which the three measuring devices of the detection device are arranged at least adjacently to one another. Expressed differently, the measurement surfaces of the measuring devices are arranged at least adjacently to one another in the longitudinal direction. The measurement surfaces of the three measuring devices expressed very roughly alternate in the longitudinal direction of the measurement surfaces.

Optionally, the measurement surfaces of all three measuring devices have essentially the same width.

Essentially herein means that the maximal widths of the measurement surfaces of the three measuring devices deviate from one another by maximally 0.5 m. In particular this can mean that they differ from one another by maximally 0.3 m. For example the maximal widths of the measurement surfaces of the three measuring devices can differ from one another by maximally 0.1 m.

One advantage of the essentially equally large width of the measurement surfaces of the three measuring devices lies in the fact that given measurements which are shifted in the longitudinal direction of the measurement surfaces, the three measuring devices essentially cover the same width of the ground surface, by which means the detection surface is correspondingly large. Expressed differently, in this manner little or even no ground surface is surveyed by only one part of the measuring devices and thus does not belong to the detection surface. Unnecessary measurements are avoided in this manner and the efficiency of the detection device is increased.

### BRIEF DESCRIPTION OF THE DRAWINGS

The subject-matter of the invention is explained hereinafter in more detail by way of a preferred embodiment example which is represented in the accompanying drawings. In each case shown schematically are:

FIG. 1 a detection device from above, with schematically drawn-in measurement surfaces of the three measuring devices;

FIG. 2 the detection device of FIG. 1 in a lateral view, with schematically drawn-in measurement regions of the three measuring devices;

FIG. 3 the detection device of FIG. 1 from above with a holding device;

FIG. 4 the detection device of FIG. 1 from above with details of the three measuring devices;

FIG. 5 the detection device of FIG. 1 in a view from above, fastened to a transport means;

FIG. 6 the detection device with transport means of FIG. 5 in a lateral view.

### DETAILED DESCRIPTION OF THE INVENTION

Basically, in the figures the same parts are provided with the same reference numerals.

The plane of the drawing and orientation of the figures are referred to by the terms left, right, below and above. A numbering of the figure is arranged for example at the bottom in the middle of the figure.

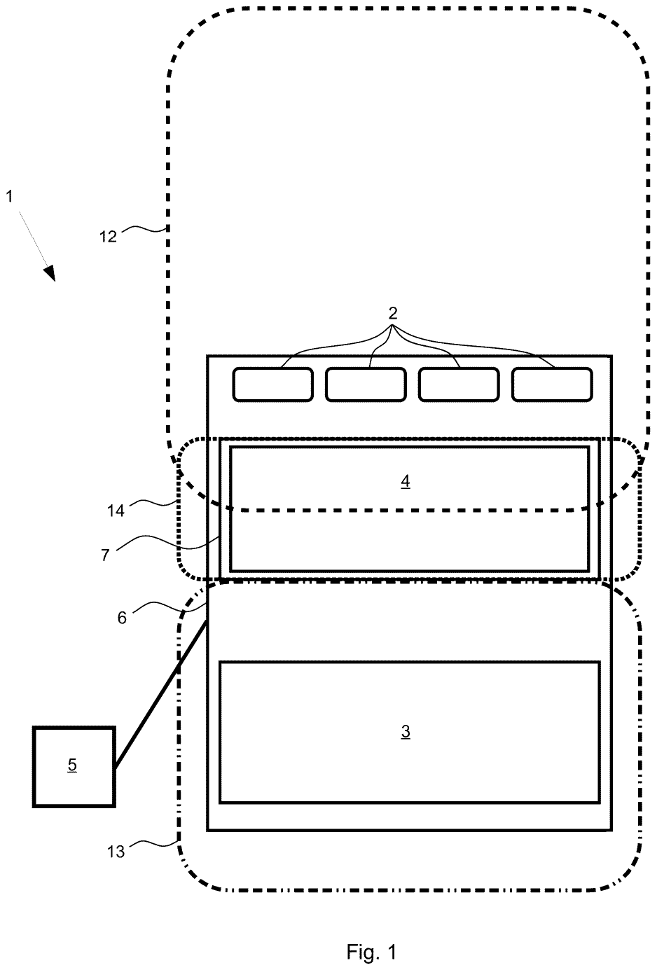

FIG. 1 shows a detection device 1 according to the invention from above. A first measuring device 2 for a magnetic field measuring method with at least one gradiometer, a second measuring device 3 for an electromagnetic measuring method from the field of time-domain methods and a third measuring device 4 for a ground radar method are arranged in a device housing 6. An evaluation device 5 which is encompassed by the detection device 1 is arranged outside the device housing 6. The first measuring device 2 includes a measurement surface 12 which is arranged at least adjacently to a measurement surface 14 of the third measuring device 4. In this case, a lower part of the measurement surface 12 of the first measuring device 2 intersects with roughly half the upper part of the measurement surface 14 of the third measuring device 4. The measurement surface 14 of the third measuring device 4 in turn is arranged at least adjacently to a measurement surface 13 of the second measuring device 3, in the present case arranged in an adjacent manner: the measurement surface 14 of the third measuring device 4 is directly adjacent to the measurement surface 13 of the second measuring device 3 and is arranged above the latter. The measurement surfaces 12, 13, 14 of all three measuring devices 2, 3, 4 extend over the whole width of the device housing 6 and go a little beyond this, expressed more precisely go equally far beyond the device housing 6 to the left and the right.

The evaluation device 5 is arranged outside the device housing 6 but is connected to this by cable, in order to be able to receive the signals of all measuring devices 2, 3, 4 of the detection device 1. The evaluation of the signals of all measuring devices 2, 3, 4 is effected in real-time. The connection by cable and the arrangement outside the device housing 6 permit an efficient function of the evaluation device 5 with as little as possible disturbance of the measuring devices 2, 3, 4.

The first measuring device 2 includes four separate elements and is arranged at the upper end of the device housing 6 in order to be subjected to as little as possible interference influence by other components of the detection device 1. The third measuring device 4 is arranged below the first measuring device 2. The third measuring device 4 is herein partly surrounded by a shielding housing 7 (completely surrounded in the plane of FIG. 1; to the top, bottom, left and right). By way of the shielding housing 7 which is completely encompassed by the device housing 6, the third measuring device 4 is electromagnetically shielded as best as possible from the first measuring device 2 as well as from the second measuring device 3, in order to minimise interfering influences upon the first measuring device 2 and the second measuring device 3. The second measuring device 3 is arranged at the lower end of the device housing 6, below the third measuring device 4 and its shielding housing 7. The third measuring device 4 is therefore located between the first measuring device 2 and the second measuring device 3, and this represents a deliberate spatial arrangement of precisely these three measuring devices 2, 3, 4 which is advantageous for a measuring quality of the measuring devices 2, 3, 4. The shielding housing 7 surrounds the third measuring device 4 in FIG. 1 not only to the left and right, but also to the top-but not to the bottom.

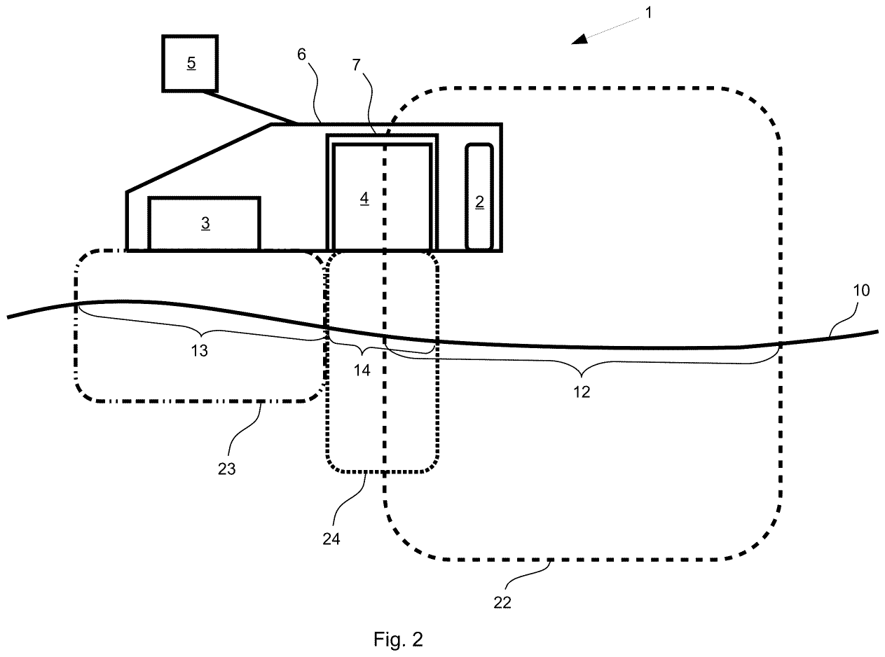

The same detection device 1 as is shown in FIG. 1 is shown in FIG. 2 but this time in a lateral view. A ground surface 10 is also drawn in and measurement regions 22, 23, 24 of all three measuring devices 2, 3, 4. The measurement regions 23 of the second measuring device 3 and of the measuring device 24 of the third measuring device 4 extend only below the device housing 6 downwards to the ground surface 10 and into this. Herein, the measurement region 23 of the second measuring device 3 penetrates below the ground surface 10 to a lesser extent than the measurement region 24 of the third measuring device 4. The measurement region 22 of the first measuring device 2 in contrast not only extends below the device housing 6 in the direction of the ground surface 10 and therebelow (and this being further downwards than that of the other two measuring devices 3, 4), but the measurement region 22 of the first measuring device 2 also extends into the device housing 6 and even beyond this to the top.

Those parts of the ground surface 10 which intersect with the measurement regions 22, 23, 24 of the three measuring devices 2, 3, 4 are the measurement surfaces 12, 13, 14 of the respective measuring devices 2, 3, 4.

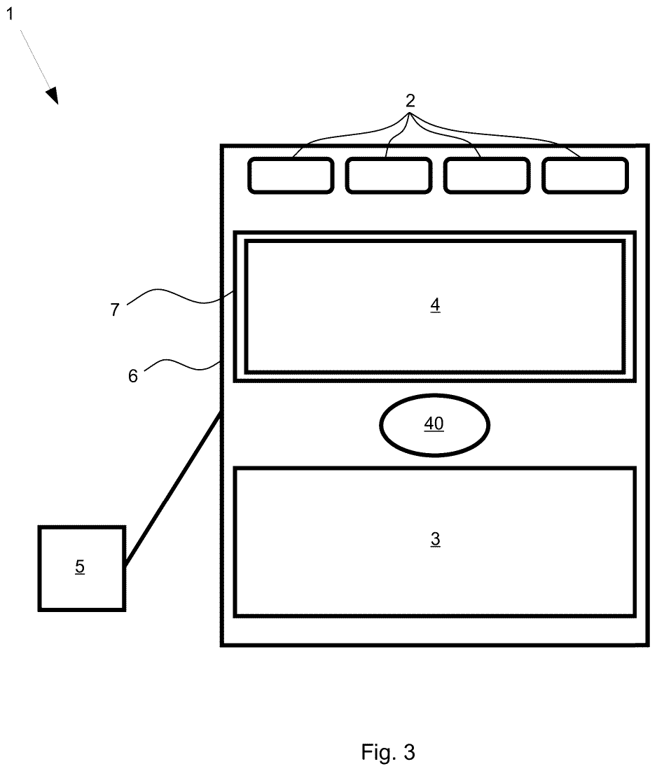

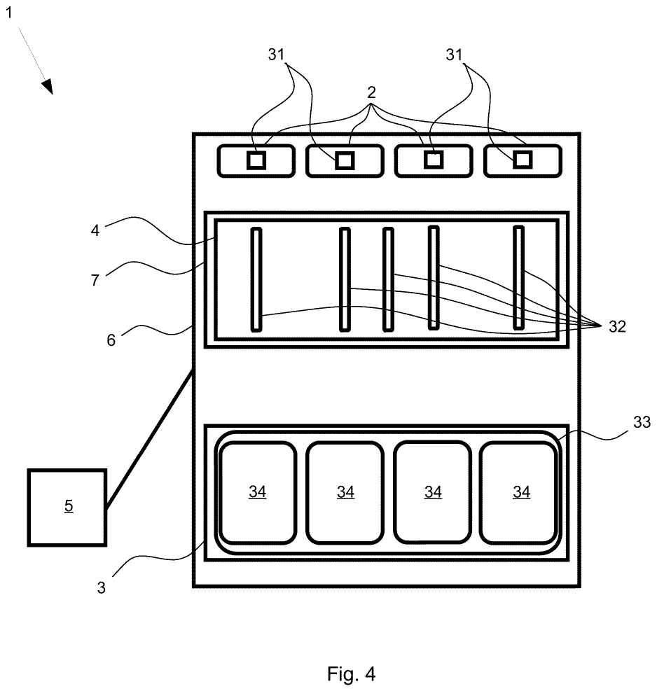

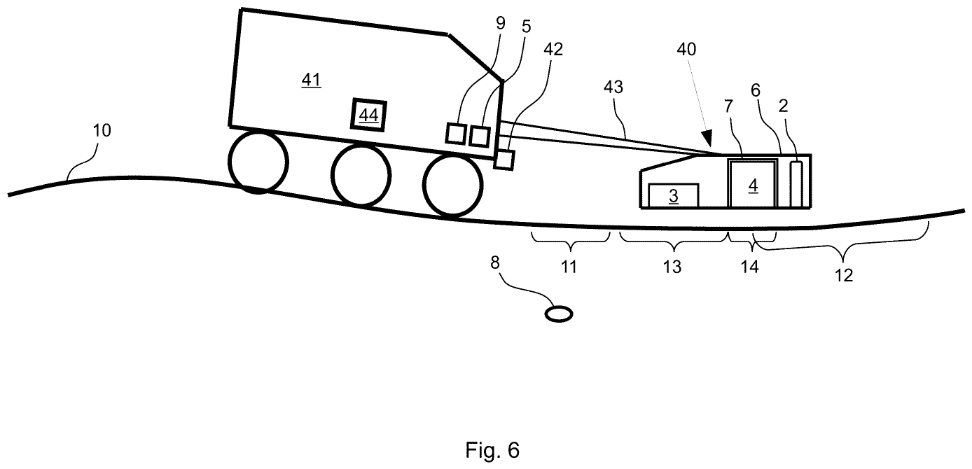

FIGS. 3 and 4 show the detection device 1 of FIG. 1, and specifically likewise from above. A holding device 40 which serves for a fastening of the detection device 1 or expressed more precisely its device housing 6, to a transport means 41 (not drawn in FIG. 3) is drawn in FIG. 3. The detection device 1 and herewith the measurement surfaces 12, 13, 14 of all measuring devices 2, 3, 4, which are located therein can be moved thanks to the transport means 41. In this manner, parts of the ground surface 10 lie in different measurement surfaces 12, 13, 14 at different points in time. A detection surface 11 (see FIG. 6) is a part of the ground surface 10 which has already been situated in the measurement surfaces 12, 13, 14 of all three measuring devices 2, 3, 4. The holding device 40 is arranged between the second measuring device 3 and the third measuring device 4, and hence the first measuring device 2 is distanced further from the holding device 40 than the second measuring device 3 and the third measuring device 4.

Details of the three measuring devices 2, 3, 4 are shown in FIG. 4. The four separate elements of the first measuring device 2 each include a fluxgate sensor 31. Five Vivaldi antennae 32 are arranged within the third measuring device 4, each parallel to one another and with their longitudinal axis (which corresponds to a dipole of the Vivaldi antennae 32) aligned from the bottom to the top. And four receiving coils 34 which are encompassed by a single emitting coil 33 are arranged next to one another in the second measuring device 3.

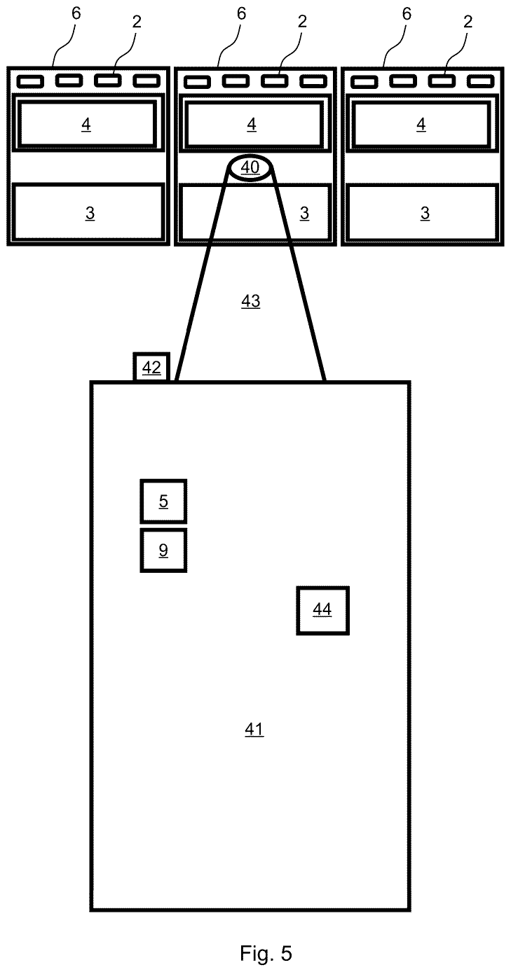

FIG. 5 shows the detection device 1 of FIG. 1 likewise from above, but this time fastened to the transport means 41. Moreover, a modular design of the detection device 1 can be seen in FIG. 5: the device housings 6 of several detection devices 1 can be arranged next to one another, in order to connect the measurement surfaces 12, 13, 14 of all three measuring devices 2, 3, 4 of a detection device 1 to adjacent measurement surfaces 12, 13, 14 of adjacent detection devices 1 into correspondingly wider total measurement surfaces which extend over all device housings 6 which are coupled to one another. In the present embodiment, three detection devices 1 are combined with one another by way of a further one being fastened thereto to the left and right in each case. Given a width of a device housing of 1.2 m, a total width of all three device housings of 3.6 m and accordingly wide total measurement surfaces of all measuring devices 2, 3, 4 result. The device housings 6 of all three detection devices 1 are held on the holding device 40 of the middle device housing 6, in order to be positioned in a contact-free manner and at a low distance to the ground surface 10. The evaluation device 5 is capable of evaluating the signals of all measuring devices 2, 3, 4 of all three detection devices 1 in real time.

The transport means 41 is a land vehicle which includes a fastening arm 43. The fastening arm 43 engages on the holding device 50 of the device housing 6 of the middle detection device 1. The three device housings 6 are arranged in a spatially remote manner from the transport means 41 by way of the elongate fastening arm 43, in order to influence the measuring devices 2, 3, 4 in the device housings 6 as little as possible. The first measuring device 2 is herein arranged furthest away from the transport means 41. The evaluation device 5 and furthermore a control device 9 and a display device 44 are arranged in the transport means 41. The control device 9 controls a temporal sequence of measuring procedures of the first measuring device 2 and of the second measuring device 3 of all three detection devices, wherein a main cycle for measuring cycles is 111 Hz. A measuring frequency for the third measuring device 4 is 10 Hz. The display device 44 graphically represents position information of a target object 8 below the detection surface 11. Furthermore, the transport means 41 includes an object marking device 42 which permits the attachment of markings on the ground surface 10. Such markings can mark locations or regions of the ground surface 10, below which a target object 8 is located or suspected.

The detection device 1 with transport means 41 of FIG. 5 is represented in a lateral view in FIG. 6. Herein, the ground surface 10, a target object 8 lying therebelow and the detection surface 11 are also represented. The transport means 41 typically moves to the right in FIG. 6 in the case of application. Herewith, a part of the ground surface 10 is firstly covered by the measurement surface 12 of the first measuring device 2, subsequently by the measurement surface 14 of the third measuring device 4 and finally by the measurement surface 13 of the second measuring device 3. As soon as a part of the ground surface 10 has been situated in all measurement surfaces 12, 13, 14 of all three measuring devices 2, 3, 4, it is then denoted as a detection surface 11. Position information of the target object 8 below the detection surface 11 can be determined by way of a combination of all evaluated signals of all measuring devices 2, 3, 4 of all detection devices 1 which is effected in the evaluation device 5, and this information graphically displayed in the display device 44.

1. A detection device for detecting an explosive target object which is arranged up to maximally 6 m deep below a ground surface, comprising a first measuring device for a magnetic field measuring method with at least one gradiometer, a second measuring device for an electromagnetic measuring method from the field of time-domain methods, a third measuring device for a ground radar method and an evaluation device, wherein a measurement surface of each measuring device is arranged at least adjacently to at least one measurement surface of one of the two other measuring devices, wherein the evaluation device is capable of receiving signals of the first, second and third measuring device and of evaluating them each in real-time, and the evaluation device is capable of providing position information of the target object below a detection surface which was situated in the measurement surfaces of all three measuring devices, from a combination of the evaluated signals of the first, second and third measuring device.

2. The detection device according to claim 1, wherein the detection device comprises a control device which sets a temporal sequence of measurements of the first and of the second measuring device, wherein in particular the control device sets a main cycle for measuring cycles of 1 Hz to 10 kHz.

3. The detection device according to claim 1, wherein the third measuring device for the ground radar method is arranged spatially between the first measuring device for the magnetic field measuring method and the second measuring device for the electromagnetic measuring method, and wherein the first measuring device is arranged at a distance of at least 0.5 m from the second measuring device.

4. The detection device according to claim 1, wherein the third measuring device for the ground radar method is encompassed at least partly by a metal-containing shielding housing which spatially separates the third measuring device from the first measuring device and from the second measuring device and electromagnetically shields it at least partly.

5. The detection device according to claim 1, wherein the third measuring device is designed for an application of an impulse radar method as a ground radar method.

6. The detection device according to claim 5, wherein the third measuring device comprises a radar signal emitter which is capable of emitting a rectangular impulse with an impulse duration of maximal 5 ns as an emitting signal.

7. The detection device according to claim 1, wherein the third measuring device as a radar signal receiver comprises at least two Vivaldi antennae which are arranged parallel to one another.

8. The detection device according to claim 1, wherein the second measuring device is designed for an application of a pulse induction method as an electromagnetic measuring method, wherein with regard to the pulse induction method an evaluation of an attenuation time of the feedback impulse is effected.

9. The detection device according to claim 8, wherein the second measuring device comprises at least one emitting coil and at least three receiving coils.

10. The detection device according to claim 1, wherein the detection device comprises a holding device for a non-positive and contact-fit connection of the detection device to a transport means, wherein the holding device is arranged on the detection device in a manner such that the holding device is closer to the second measuring device than to the third measuring device, and the holding device is closer to the second measuring device than to the first measuring device.
